(19) United States
(12) Patent Application Publication
(10) Pub. No.: US 2015/0168247 A1
(43) Pub. Date: Jun. 18, 2015

(54) SYSTEM FOR MEASURING THE CHANGE IN RELATIVE DISTANCE BETWEEN PIGS MOVING IN A PIPELINE

(71) Applicant: Daniel Gundersen, Calgary (CA)

(72) Inventor: Daniel Gundersen, Calgary (CA)

(21) Appl. No.: 14/132,088

(22) Filed: Dec. 18, 2013

(51) Int. Cl. G01M 3/00; G01S 13/08; G01S 15/08; G01C 22/02

(52) U.S. Cl. CPC G01M 3/005; G01C 22/025; G01S 13/08; G01S 15/08; G01N 2291/102

(57) ABSTRACT

A system for measuring the relative distance between pipeline pigs moving in a pipeline is provided. The system includes a means for measuring the relative distance between the pipeline pigs as the pigs move through the pipeline to enable a determination of the change of the relative distance between the pigs as they move through the pipeline. In an embodiment, the relative distance between the pigs is measured and recorded using one or more transceivers carried by one or more pigs. Other embodiments for measuring and recording the relative distance between pigs moving in a pipeline are also disclosed.

### FIELD OF THE INVENTION

The present invention relates generally to measuring the distance between two objects moving in a pipeline or the like, and more particularly, relating to a system and method for measuring the change in relative distance between pigs moving in a pipeline and recording the measured distance over time.

### BACKGROUND OF THE INVENTION

Pipeline pigs are commonly used for many purposes by pipeline operators, utility companies, oil and gas companies and others to operate and maintain conduits of all types including pipelines used for transporting various substances. Pipeline pigs are commercially available in many different designs and configurations suitable to many purposes including, but not limited to, cleaning, scraping, brushing, fluid removal, fluid separation, inspection, chemical application, such as chemical corrosion inhibitors that are often intended to be applied as thin films, and many other purposes.

In application, pipeline pigs are typically placed into a pipeline by a pig launching apparatus and then transported through the pipeline to an endpoint by hydraulic or gas pressure caused by the substance flowing in the pipeline. The pig is removed from the pipeline via a pig receiving apparatus.

In some instances, multiple pigs may be used together to perform an operation in a single pipeline. For example, the interior of a pipeline may be coated with a thin film of corrosion inhibitor chemicals by using a lead sealing pig followed by a slug of corrosion inhibitor chemicals which is in turn followed by a tail or filming pig. Additionally, multiple pigs can be used to transport more than one type of fluid in the same pipeline by separating the different types of fluids between pigs. Further, multiple pigs may be combined to make a more reliable seal.

In certain instances, where more than one pig is used, it would be beneficial to know the change in the relative distance between the pigs as they move through the pipeline. Knowing the relative distance between the pigs as they move through the pipeline allows an operator to determine if the pigs properly performed their purpose. For example, when performing a chemical application to the pipeline, knowing the change in relative distance between the pigs as they move through the pipeline would allow an operator to evaluate the effectiveness of the operation in order to determine if the chemical was properly applied to the interior surface of the pipeline. Knowing this information would also be useful in detecting problems in the pipeline. With respect to separation of fluids, measuring the distance between the pigs and confirming that the distance was consistent would be an effective way to confirm that fluid separation was satisfactory.

Systems are known in the art for measuring the location of a pig in a pipeline. External systems typically consist of single-point sensors. It could be possible to install numerous sensors along a pipeline in order to measure pig location, but there are practicality and cost considerations that make this difficult. Internal systems, such as those used with smart pigs, have been used to measure the location of single pigs within a pipeline.

While the devices heretofore fulfill their respective particular objectives and requirements, they do not provide a system for measuring the relative distance between pigs moving in a pipeline, for measuring the change in the relative distance between pigs moving in a pipeline, and for recording the relative distance over time on a relatively continuous basis to determine if an operation using the pigs was successfully completed. As such there exists a need for a system for measuring the change in relative distance between pigs moving in a pipeline, which substantially departs from the prior art, and in doing so provides an apparatus primarily developed for the purpose of measuring and recording the distance between two or more pigs as they travel through a pipeline.

### SUMMARY OF THE INVENTION

In view of the foregoing disadvantages inherent in the known types of pig monitoring systems including sensor arrangements now present in the prior art, embodiments of the present invention provides a new system for measuring the relative distance between pigs moving in a pipeline.

Embodiments of the present invention also provide a system and method for recording the relative distance between pigs moving in a pipeline.

Embodiments of the present invention also provide a system and method of reduced complexity and expense while increasing monitoring accuracy.

In general, in one aspect, a system for measuring the relative distance between pigs moving in a pipeline is provided. The system includes first and second pipeline pigs; and a means for measuring the relative distance between the first and second pipeline pigs as they move through a pipeline, the means being carried by at least one of the first or second pipeline pigs.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a cross-sectional view of a system for measuring the relative distance between pipeline pigs moving in a pipeline that is constructed in accordance with the principles of an embodiment of the present invention;

FIG. 2 is a cross-sectional view of the system for measuring relative distances between pipeline pigs, showing a film on the interior wall of the pipeline;

FIG. 3 is a cross-sectional view of the system for measuring relative distances between pipeline pigs, showing an auxiliary transceiver;

FIG. 4 is a cross-sectional view of the system for measuring relative distances between pipeline pigs, showing wheeled odometers.

### DETAILED DESCRIPTION OF THE INVENTION

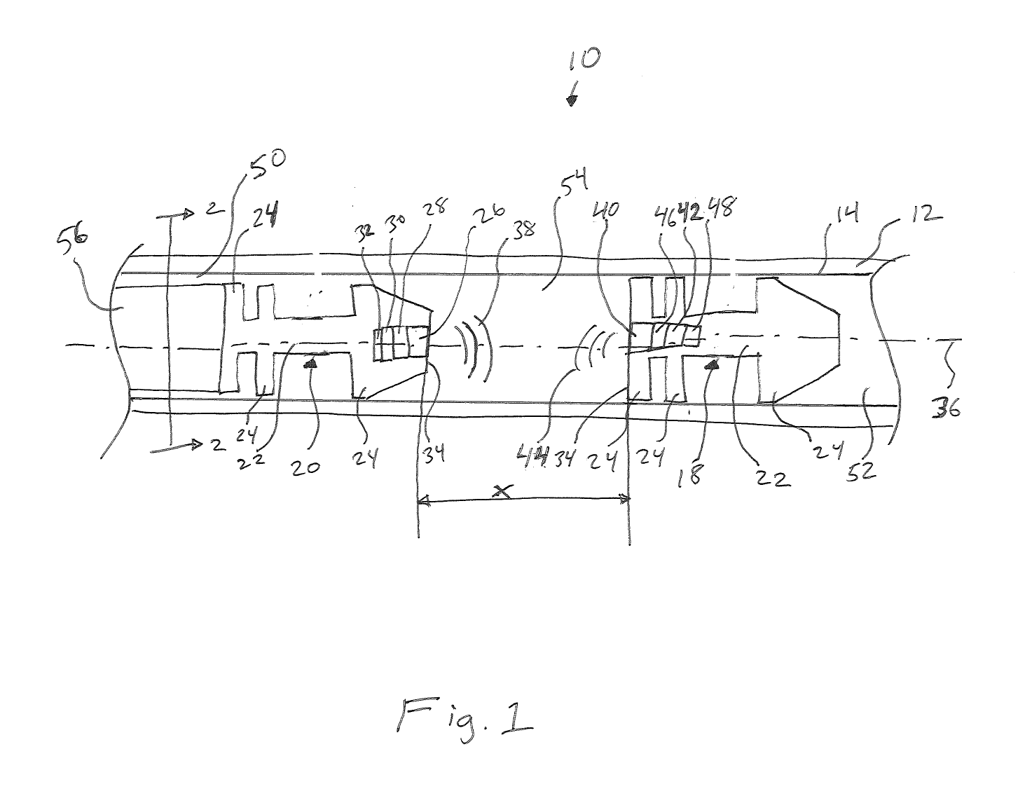

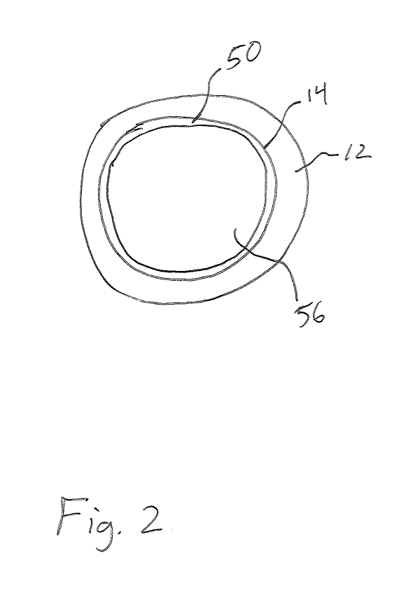

With reference to FIGS. 1 and 2, there is representatively illustrated a new system 10 for measuring the relative distance between pipeline pigs moving in a pipeline and determining the change in relative distance overtime as the pigs move in the pipeline. While system 10 is illustrated in FIGS. 1-3 in connection with a pipeline corrosion inhibitor chemical application operation, it is to be understood that the invention is not limited in practice to only applying chemicals to a pipeline and can be used in many other pipeline operations.

With continued reference to FIGS. 1 and 2, system 10 includes two pigs, representatively illustrated as a sealing pig 18 and a filming pig 20, disposed within a pipeline 12 for transport through the pipeline. The sealing pig 18 is positioned forwardly of the filming pig 20 and a quantity of fluid 54, to be applied to the interior wall of the pipeline, is disposed between the two pigs. As pigs 18 and 20 move through the pipeline 12, fluid 54 is applied to the interior wall of the pipeline as film 50. Appling the film 50 reduces the quantity of fluid 54 between pigs 18 and 20 causing the relative distance X between the pigs 18 and 20 to decrease.

The rate of change of the relative distance X between the pigs 18 and 20 during the chemical application process can be used to determine whether the film 50 was correctly applied. For example, if the relative distance decreases rapidly at the beginning of the pipeline perhaps to the point where the pigs contact each other mid-line, it may be determined the chemical was not applied optimally, and the latter half of the pipeline may not be coated properly. Similarly, if the relative distance decreases at a rate lower than expected, it may be determined that an inadequate amount of chemical was left behind, which would be an ineffective application. Further, if the rate of change is inconsistent, problems within the pipeline may be inferred.

To determine the rate of change in the relative distance X, the system 10 operates to measure and record the relative distance between the pipeline pigs 18 and 20 as they move through the pipeline. This is accomplished, in one embodiment, by using acoustics to measure the distance between the pigs. Illustratively, one of the pigs 18, 20 includes a transceiver 26, a clock 28, a power supply 30, and memory 32. The transceiver 26 is mounted to the pig 18, 20 near an exterior wall 34 facing the direction to be measured along a center axis 36 of the pipeline 12. The transceiver 32 is electrically connected to the power supply 30, and the memory 32.

The transceiver 26 is, in one embodiment, an acoustic transceiver designed to send and receive acoustic signals. The transceiver 26 may alternatively be a low frequency radio wave transceiver designed to send and receive low frequency radio waves. The transceiver may also be any other type of transceiver known in the art.

The clock 28 may be mounted at any location on the pig 16 and is electrically connected to the power supply 30, and the memory 32. The memory 32 may be mounted at any location on the pig 16 and is electrically connected to the transceiver 26, the clock 28, and the power supply 30. The memory 32 will preferably be a solid state memory.

The power supply 30 may be mounted at any location on the pig 16 and is electrically connected to the transceiver 26, the clock 28, and the memory 32. The power supply 30 is at least one battery. The battery may be a replaceable battery, or a built-in rechargeable battery.

In operation, a lead pig 18 travels within the pipeline 12 upstream of the trailing pig 20 separated by a distance X. Although the lead pig 18, the trailing pig 20, or both pigs 18 and 20 may be the measurement pig, the operation will be described with the trailing pig 20 as the measurement pig for clarity. In instances where the lead pig 18, is the measurement pig, the equipment described on each and directions of signals would be reversed.

The transceiver 26 is preferably positioned in the front area of the trailing pig 20 facing the upstream direction so that it can send acoustic signals through the chemical 54 substantially along the center axis 36 of the pipeline 12. A measurement signal 38 is sent from the transceiver 26 toward the lead pig 18. In this embodiment, the signal 38 reflects off of the lead pig 18 and returns in a downstream direction through the chemical 54 substantially along the center axis 36 of the pipeline 12. The transceiver 26 receives the signal 38 when it returns to the transceiver 26. The clock 28 measures the amount of time required from the time the signal 38 is sent until the signal 38 is received. The amount of time recorded by the clock 28 is stored on the memory 32. The steps of sending the signal 38, receiving the signal 38, and recording the time between sending and receiving the signal 38 are repeated at a preset frequency thereby giving a continuous monitoring of the distance between the pigs 18 and 20 as they travel through the pipeline 12.

Upon removal of the pigs 18 and 20 from the pipeline 12, a user may attach a computer to the memory 32 and retrieve the data from the memory 32. The data provides the time required from the signal 38 being sent from the transceiver 26 to the signal 38 being received by the transceiver 26. By knowing the rate of transmission of the signal 38 through fluid between the transceiver 26 and the lead pig 18, the distance between the lead pig 18 and the trailing pig 20 can be calculated for each signal sent from the transceiver 26 and received by the transceiver 26.

Alternative embodiments may include a second transceiver 40 and a second power supply 42 on the lead pig 18 for receiving the signal 38. In these embodiments the second transceiver 40 will send a return signal 44 to the first transceiver 26 rather than requiring a natural reflection of the original signal. The amount of time recorded by the clock 28 between the transceiver 26 sending the signal 38 and receiving the return signal 44 from the second transceiver 40 is stored on the memory 32. The steps of sending the signal 38, receiving the return signal 44, and recording the time between sending the signal 38 and receiving the return signal 44 are repeated at a preset frequency thereby giving a continuous monitoring of the distance between the pigs 18 and 20 as they travel through the pipeline 12. Alternative embodiments may further include a second clock 46 and a second memory 48 for tracking time between signals 38 received by the second transceiver 40 and storing the amount of time.

An exemplary operation for which it would be advantageous to track the distance between the pigs 18 and 20 as they travel through the pipeline 12 is in an operation where a thin film of chemical 50 is applied to the inner surface 14 of the pipeline 12. In this operation the lead pig 18 seals the transported fluid 52 from the chemical 54. The trailing pig 20 is commonly, although not necessarily, designed with a tail disc 24 which is sized to the inner diameter 14 of the pipeline thereby allowing some of the chemical 54 to remain on the inner diameter 14 of the pipeline 12 as the trailing pig 20 passes through the pipeline 12. The chemical 54 that remains on the inner diameter of the pipeline 12 creates a film 50.

Because some of the chemical 54 becomes the film 50, the amount of chemical 54 between the lead pig 18 and the trailing pig 20 is reduced as the lead pig 18 and the trailing pig 20 travel through the pipeline 12. As the chemical 54 is reduced in volume, the trailing pig 20 moves closer to the lead pig 18. For this reason, it is advantageous to know the relative distance between the lead pig 18 and the trailing pig 20 because it provides the rate of deposit of the chemical 54 to the inner diameter of the pipeline 12. Examination of the rate of deposit of the chemical provides the user with information pertaining to not only the consistency of the film 50, but also possible trouble areas along the length of the pipeline such as decreased diameter, increased diameter, or other issues.

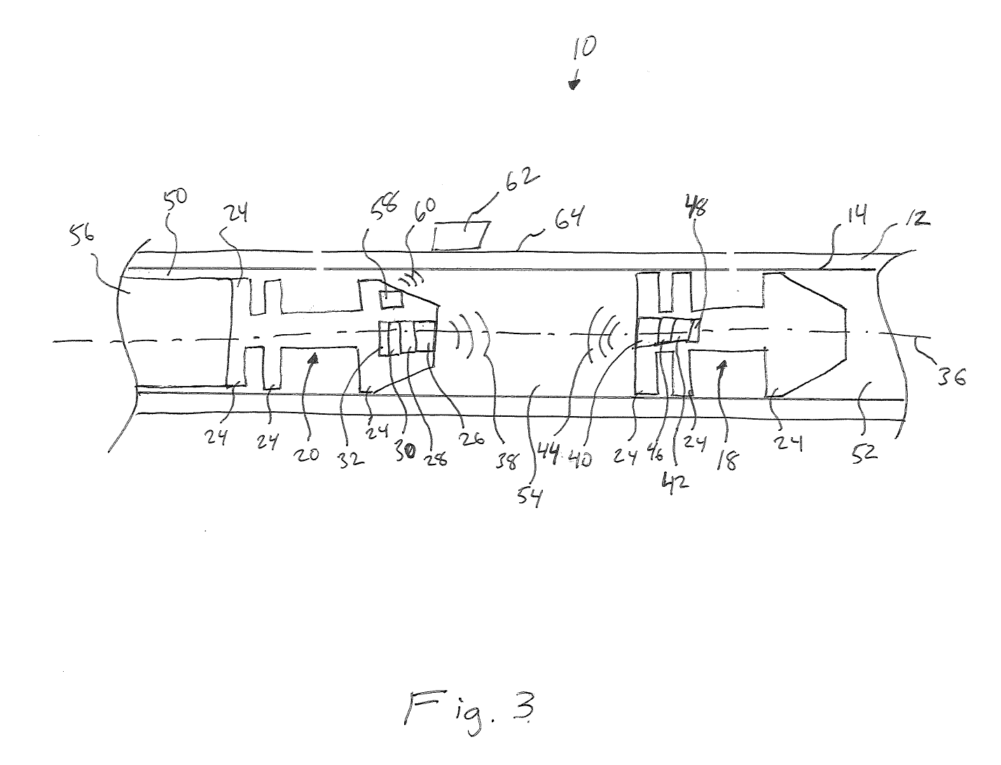

With reference to FIG. 3, other alternative embodiments may further include an auxiliary transceiver 58 on the lead pig 18, the trailing pig 20 or both the lead pig 18 and the trailing pig 20. The auxiliary transceiver 58 sends and receives signals 60 to and from exterior transceivers or receivers 62 located outside of the exterior 64 of the pipeline 12. Signals 60 include the data received from the clock 28 and stored in the memory 32. This allows a user to receive information regarding the distance between the pigs 18 and 20 while the pigs 18 and 20 are still within the pipeline 12. If control of one or more of the pigs is required, the exterior transceiver 62 would then send a signal back to the pig(s).

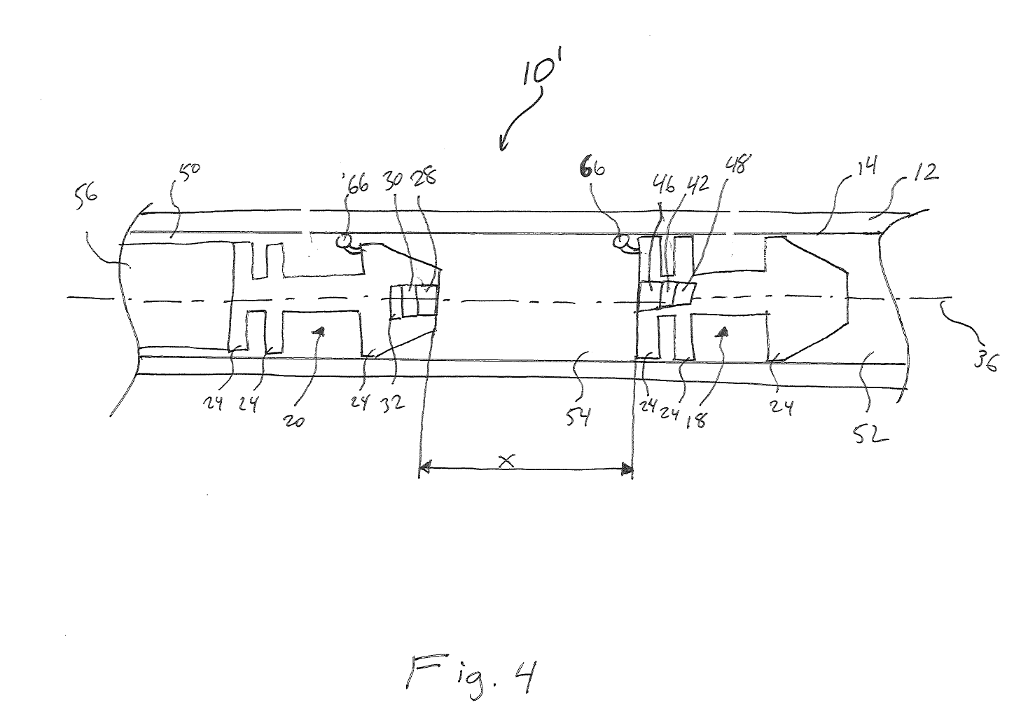

Alternatively to wireless technology, the rate of change of the relative distance between the moving pigs can be determined using mechanical system. With reference to FIG. 4, an alternative embodiment 10′ for measuring the relative distance between pipeline pigs moving in a pipeline is illustrated, wherein the same reference numbers refer to elements previously discussed. In this embodiment, the lead pig 18 and trailing pig 20 include wheeled odometers 66 adapted to contact the inner diameter 14 of the pipeline 12. The wheeled odometers 66 measure the distance travelled by lead pig 18 and trailing pig 20. As an alternative to wheeled odometers 66, inertial navigation measurement or other location measurement systems may be used.

In operation, the clock 28 and the second clock 46 will be synchronized prior to installation of the lead pig 18 and the trailing pig 20 into the pipeline 12. The wheeled odometers 66 measure the distance travelled over a certain amount of time and record this amount on the second memory 48 and the memory 32, respectively. Recording of data occurs at a preset frequency.

Upon removal of the lead pig 18 and the trailing pig 20 from the pipeline 12, the data recorded to the memory 32 and second memory 48 can be downloaded onto a computer and compared relative to each other to determine the distance travelled by the lead pig 18 and the trailing pig 20 at each data point stored in the memory 32 and second memory 48. From the distances travelled, the user can calculate the relative distance between the lead pig 18 and the trailing pig 20 at each data point stored in the memory 32 and the second memory 48.

A number of embodiments of the present invention have been described. Nevertheless, it will be understood that various modifications may be made without departing from the spirit and scope of the invention. Accordingly, other embodiments are within the scope of the following claims.

What is claimed is:

1. A system for measuring the relative distance between pipeline pigs moving in a pipeline, the system comprising:
first and second pipeline pigs; and
a means for measuring the relative distance between said first and second pipeline pigs as they move through a pipeline, said means being carried by at least one of said first or second pipeline pigs.

2. The system of claim 1, wherein said means records the relative distance between said first and second pipeline pigs as said pipeline pigs move through a pipeline.

3. The system of claim 2, wherein said means includes a transceiver, a clock, a power supply, and a memory.

4. The system of claim 3, wherein said transceiver is selected from the group consisting of an acoustic transceiver, a radio wave transceiver, and low frequency radio wave transceiver.

5. The system of claim 4, wherein said at least one of said first or second pipeline pigs further comprises an auxiliary transceiver that communicates with an external transceiver.

6. The system of claim 1, wherein said means includes said first pipeline pig comprising a first transceiver, a first clock, a first power supply, and a first memory and said second pipeline pig comprising a second transceiver and a second power supply.

7. The system of claim 6, wherein at least one of said first or second pipeline pigs further comprises an auxiliary transceiver that communicates with an external transceiver.

8. The system of claim 6, wherein said first pipeline pig further comprises a first auxiliary transceiver and said second pipeline pig further comprises a second auxiliary transceiver that both communicate with an external transceiver.

9. A system for measuring the relative distance between pipeline pigs moving in a pipeline, the system comprising:
first and second pipeline pigs
wherein said first pipeline pig comprises a first wheeled odometer, a first clock, a first power supply, and a first memory; and
wherein said second pipeline pig comprises a second wheeled odometer, a second clock, a second power supply, and a second memory.

10. The system of claim 9, wherein said first clock and said second clock are adapted to be synchronized.

11. The system of claim 9, wherein at least one of said first or second pipeline pigs further comprises an auxiliary transceiver that communicates with an external transceiver.
